(19) United States
(12) Patent Application Publication
(10) Pub. No.: US 2009/0308846 A1
(43) Pub. Date: Dec. 17, 2009

(54) SYSTEM AND METHOD FOR VERTICAL MOMENT CONNECTION

(76) Inventor: WILLIAM L. BONG, Walnut Creek, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/483,977

(22) Filed: Jun. 12, 2009

Related U.S. Application Data
(60) Provisional application No. 61/061,739, filed on Jun. 16, 2008.

(51) Int. Cl. B23K 25/00

(52) U.S. Cl. 219/73.1

(57) ABSTRACT

A system for narrow-gap electroslag-welded moment connections welded between vertical column flanges includes vertical column doubler plates with top and bottom stiffeners and horizontal beam side plates aligned with the doubler plates to carry the moment load through the vertical support columns. An embodiment includes an elliptical radius in each side plate. Disclosure of an automated modular method for narrow-gap electroslag-welded moment connections is included.

### CROSS-REFERENCES TO RELATED APPLICATIONS

This United States non-provisional patent application is based upon and claims the filing date of U.S. provisional patent application Ser. No. 61/061,739 filed Jun. 16, 2008.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to welding. More particularly, the invention is related to a system and method for narrow-gap electroslag-welded moment connections (welded between the two vertical column flanges) for the construction of low-rise and high-rise buildings.

### BACKGROUND OF THE INVENTION

My U.S. Pat. No. 6,297,472, issued Oct. 2, 2001, discloses and claims a welding system and method comprising a distributed welding control system that allows a welding operator to program automated welding cycles for various welding operations, that is particularly useful for installing stiffener plates onto structural beams. In U.S. Pat. No. 6,297,472, the welding system comprises a welding fixture with a pair of opposing, positionally adjustable welding shoes, and lock screws for attaching a workpiece such as an I-beam. A rotary wire straightener removes the cast and helix from welding wire as it is fed to the welding torch. Straightening the welding wire prevents welding wire from fusing to the copper shoes and keeps the weld puddle in the center of the weld cavity in a manner that would interrupt the welding operation or cause a weld defect.

My U.S. Pat. No. 7,038,159, issued May 2, 2006, discloses and claims a system and method for electroslag butt welding expansion joint rails comprising a distributed welding control system. The method includes defining a weld cavity with a first expansion joint rail, a second expansion joint rail, a plurality of gland shoes, and a pair of butt shoes, and can be adapted for welding an expansion joint rail to a support beam.

My U.S. Pat. No. 7,148,443, issued Dec. 12, 2006, discloses and claims a consumable guide tube comprising a thin first elongate strip, a second elongated strip and a plurality of insulators. An embodiment of U.S. Pat. No. 7,148,443 comprises a thin first elongate strip which is a low carbon cold rolled steel strip, and a second elongated strip that is a low carbon hot rolled steel strip, and a second elongated strip that is a low carbon hot rolled steel strip is formed with one or more channels to allow the passage of the consumable welding wire. The guide tube of U.S. Pat. No. 7,148,443 can also be configured to comprise two or more longitudinal channels. A related patent, U.S. Pat. No. 7,550,692 [application Ser. No. 11/591,190], scheduled for issue on Jun. 23, 2009, also discloses and claims a consumable guide tube.

My U.S. patent application Ser. No. 10/731,414, filed Dec. 9, 2003 and related U.S. Pat. No. 7,429,716, discloses and claims a modular welding system for performing quick, easy and high quality welds. The modular welding system of application Ser. No. 10/731,414, and related U.S. Pat. No. 7,429,716 issued Sep. 30, 2008, includes a basic component system and a modular fixture component system. The basic component system provides the basic components necessary to perform a quality weld efficiently. The modular component system interfaces with the basic component system and provides a particular welding fixture assembly that performs a particular type of weld. More particularly, a stiffener type modular component system and a butt/tee type modular system fixture system are disclosed and claimed. The modular welding system of application Ser. No. 10/731,414, and related U.S. Pat. No. 7,429,716, easily may be integrated with the basic components of the system and method for Electroslag welding spliced vertical columns for high-rise building fabrication and erection.

The automated system and method for vertical moment connection welding combines certain disclosed and claimed features of my patents described herein, and and/or their continuation or continuation-in-part progeny, to allow a welding operator to program automated welding cycles for various welding operations; and, as a result, these patents are particularly useful for a system and method for vertical moment connection welding, and an embodiment using automated welding techniques.

### DISCLOSURE OF INVENTION

When erecting high-rise buildings (on site), horizontal beam flanges are welded to vertical column flanges by either (1) multipass “gasless flux-core” wire welding process, or (2) multipass “gas shielded flux-core” wire welding process. Either option presents a long and laborious process. To facilitate the speed of erecting a low-rise or high-rise building, Arcmatic™ has devised a method of automating the welding process to make the moment connection much stronger by welding doubler plates to the top of the stiffener plates by “boxing in” the entire moment connection area inside the vertical building column. Also by making vertical moment connection welds much faster by using a newly designed mechanized and automated welding system to facilitate the welding process, to reduce welding time, and strengthening the weld beam-to-column flange weld connection while erecting the building “on the job.”

The automated system and method for vertical moment connection welding includes (1) a web in the center of the flange, (2) four stiffener plates, (3) sixteen steel stiffener backup bars that retain the molten VertaSlag™ weld puddle, (4) a doubler plate above each of the stiffeners (located directly opposite two side plates that have been welded to the outside beam flanges) and, (5) steel backup bars above and below each stiffener-to-doubler plate weld cavity to retain the molten VertaSlag™ weld puddle. The six VertaSlag™ Weld joints are required; two to weld the top and bottom stiffeners to the web, two to weld the top doubler plates to the two top stiffener plates, and three to weld the two bottom stiffeners to the bottom doubler plate.

An embodiment of the automated system and method for vertical moment connection welding includes the following assembly sequence:
(1) two stiffeners are placed above the two slots cut in the web;
(2) the two stiffeners are held in place with one inch square backup bars tack welded on either side of each stiffener, connecting the stiffener to the web and providing a dam to retain the VertaSlag™ Weld puddle;
(3) two stiffeners are placed below the web, also held in place with two one inch square backup bars on either side of each stiffener;
(4) two backup bars are welded on either side of each four stiffeners;
(5) the top doubler plate is placed on top of the four backup bars that have been welded to the two top stiffeners, and the bottom doubler plate is placed on top of the four backup bars that have been welded to the two bottom stiffeners;
(6) the top and bottom doubler plates are then welded to the backup bars on the top and bottom stiffener plates. This attachment secures the top and bottom doubler plates in position to form the four VertaSlag™ weld cavities that will join the doubler plates to the stiffener plates;
(7) six sumps are welded to the bottom of each of the weld cavities below the bottom flange; and
(8) six “square-donut” tabs are placed above each VertaSlag™ weld joint—all six welds are now prepared for welding.

An embodiment of the automated system and method for vertical moment connection welding includes the following welding sequence:
(1) one consumable guide tube is placed inside each one of the six weld cavities, and each guide tube has sufficient insulation to keep the guide tube from shorting against the parent material;
(2) six VertaSlag™ welding torches are used, one welding torch is placed above each corresponding weld joint to hold the consumable guide tube, located inside each weld cavity;
(3) beveled copper bars are placed in the weld groove (between the doubler plate and the flange plate) to keep the weld puddle from running down the submerged arc weld joint when the VertaSlag™ weld reaches the top of the weld cavity;
(4) one or two wire feed conduits are attached to each VertaSlag™ weld torch to convey the welding wire down the guide tube to perform the VertaSlag welding operation, depending on the size of guide tube and the number of welding wires used to perform the welding operation, wherein the size of the guide tube and the number of wires used depends on the thickness of the stiffener to be welded;
(5) a sufficient number of 4/0 cables to carry the necessary welding current are attached to each of the VertaSlag™ welding torches, and each weld is initiated one at-a-time to stagger the start and stop times, and when each weld has been completed, the corresponding welding torch is removed;
(6) each remaining guide tube, starting sump, and run-off tabs are removed; and
(7) the final weld is an HD-SubArc+MP™ weld that is used to join the longitudinal side of the doubler plate to the inside of the beam flange, wherein metal powder is added to the weld joint prior to welding, and the weld is made with dual wires of any diameter (through one torch tip) at amperages between 1000 and 2000 amps.

Other features, advantages, and objects of the automated system and method for vertical moment connection welding will become apparent with reference to the following description and accompanying drawings.

These together with other objects of the automated system and method for vertical moment connection welding, along with the various features of novelty which characterize the system or method, are described with particularity in the claims attached to and forming a part of this disclosure. For a better understanding of the automated system and method for vertical moment connection welding, its operating advantages and the specific objects attained by its uses, reference should be made to the attached drawings and descriptive materials in which there are illustrated preferred embodiments of the system or method.

### BRIEF DESCRIPTION OF DRAWINGS

The above stated features, aspects, and advantages of the automated system and method for vertical moment connection welding will become better understood with regard to the following description, appended claims, and accompanying drawings as further described.

FIG. 1a is a side elevation view of a section of vertical column 500 through the doubler plates 210 with the top and bottom stiffeners 220 installed for an embodiment of the automated system and method for vertical moment connection welding.

FIG. 1b is a side elevation view of the section of vertical column of FIG. 1a through the flange depicting: (1) the web 510 in the center of the vertical flange 500 (2) four stiffener plates 220, (3) eight stiffener backup bars 230 that retain the molten VertaSlag™ weld puddle for the stiffener-to-web welds, (4) a doubler plate 210 above each stiffener 220, (5) eight steel backup bars 240 a pair on either side of the top end of each stiffener to form the stiffener-to-doubler plate VertaSlag™ weld cavity to retain the molten VertaSlag™ weld puddle during the weld cycle, and (6) six VertaSlag™ weld joints 250 (three to weld the top two stiffener plates 220 to the web 510, and the doubler plates 210; and three to weld the bottom two stiffener plates 220 to the web 510 and doubler plates 210).

FIG. 1c is a top view of FIG. 1a wherein the flange is in a vertical orientation.

FIG. 1d is a top view of FIG. 1a wherein the flange is in a horizontal orientation.

FIG. 2a is a side elevation view of the section of vertical column 500 of FIG. 1a depicting VertaSlag™ welds 250 for top and bottom stiffener plates 220.

FIG. 2b is a side elevation view of the section of vertical column 500 of FIG. 1b depicting VertaSlag™ welds for stiffener plates 220 to doubler plates 210 and stiffener plates 220 to vertical column web 510.

FIG. 2c is top view of FIG. 1c depicting VertaSlag™ welds 250 for stiffener plates 220 to doubler plates 210 and stiffener plates 220 to vertical column web 510.

FIG. 2d is a perspective view of FIG. 2a.

FIG. 3a is an end view of the horizontal beam 200 showing the side plates 260 are welded onto the horizontal beam flanges 200 with the HD-SubArc+MP welding process. Welding the side plates 260 to the beam flanges 200 allows the beam side plates to be welded to the Column flanges vertically with the VertaSlag welding process. The elliptical radius 290, cut into the side plates relieves the stress concentration where the back end of side plates 260 are welded to the beam flanges 200. The distance between the two side plates align perfectly with the two doubler plates 210, FIG. 2c. This allows the moment load to be carried through the column using the beam side plates 260 and the column doubler plates 210. These VertaSlag™ welds can be made on the building during the building erection process.

FIG. 3b is a side elevation view of the horizontal beam 200 of FIG. 3a depicting an embodiment having a side plate 260 with a radius cut into the side plate 290 to relieve stress concentration between the vertical column 500 flange and the side plate 260.

FIG. 4a is a top view of completed moment connection in the section of vertical column 500 and the completed side plate 260 welds to the corresponding horizontal beam 200 for an embodiment of the automated system and method for vertical moment connection welding.

FIG. 4b is a side elevation view of FIG. 4a.

FIG. 5 is a top view of how beam-to-column VertaSlag™ welds join the horizontal side plates to the section of vertical column for an embodiment of the automated system and method for vertical moment connection welding.

FIG. 6 is a top view of beam-to-column welds for an embodiment of the automated system and method for vertical moment connection welding depicting the transfer of moment loads through the moment connection in the vertical column.

FIG. 7 is a system schematic of operator's control interface 800 including the operator's control panel 810 and liquid crystal display (LCD) graphics panel 820, parallel input and output unit 830, display interface 840, microprocessor control unit 850, operator interface program 852, network interface program 854, system supervisor program 856, and network interface 860.

FIG. 8 is an isometric view of a representative operator's control panel 810 and LCD graphics panel 820 of FIG. 7.

FIG. 9A is a partial flow diagram of the steps of a method for an embodiment of the system and method for vertical moment connection.

FIG. 9B is the balance of the flow diagram of FIG. 9A of the steps of a method for an embodiment of the system and method for vertical moment connection.

FIG. 10A is a partial flow diagram of the steps of a method for an embodiment of the system and method for vertical moment connection.

FIG. 10B is the balance of the flow diagram of FIG. 9A of the steps of a method for an embodiment of the system and method for vertical moment connection.

FIG. 11 is a flow diagram of additional steps for step 942 of the method for an embodiment of the system and method for vertical moment connection of FIG. 10B.

### BEST MODE FOR CARRYING OUT THE INVENTION

My following U.S. Letters Patent are incorporated by reference as if fully set forth herein: U.S. Pat. No. 6,297,472 for Welding System and Method, issued Oct. 2, 2001 (the “'472 Patent”); U.S. Pat. No. 7,038,159 for Electroslag Butt-Welding Expansion Joint Rails, issued May 2, 2006 (the “'159 Patent”); U.S. Pat. No. 7,148,443 for Consumable Guide Tube, issued Dec. 12, 2006 (the “'443 Patent”); U.S. Pat. No. 7,429,716 for Modular Welding System, issued Sep. 30, 2008 (the “'716 Patent”), and U.S. Pat. No. 7,550,692 [application Ser. No. 11/591,190], scheduled for issue on Jun. 23, 2009, for Consumable Guide Tube (the “'692 Patent”).

My following pending U.S. non-provisional patent applications are incorporated by reference as if fully set forth herein: U.S. application Ser. No. 11/591,190 for Consumable Guide Tube, filed Oct. 30, 2006 (the “'190 Application”); U.S. application Ser. No. 12/212,019 for System and Method of Electroslag Welding Spliced Vertical Columns, filed Sep. 17, 2008 (the “'019 Application”); U.S. application Ser. No. 12/352,297 for System and Method of Electroslag Welding Spliced Box Columns, filed Jan. 12, 2009 (the “'297 Application”); U.S. application Ser. No. 12/474,859 System and Method for Beam-to-Column Welding, filed May 29, 2009 (the “'859 Application”); and U.S. application Ser. No. 12/475,110 for Air-Cooled Copper Shoes for Electroslag Welding Operations, filed May 29, 2009 (the “'110 Application”).

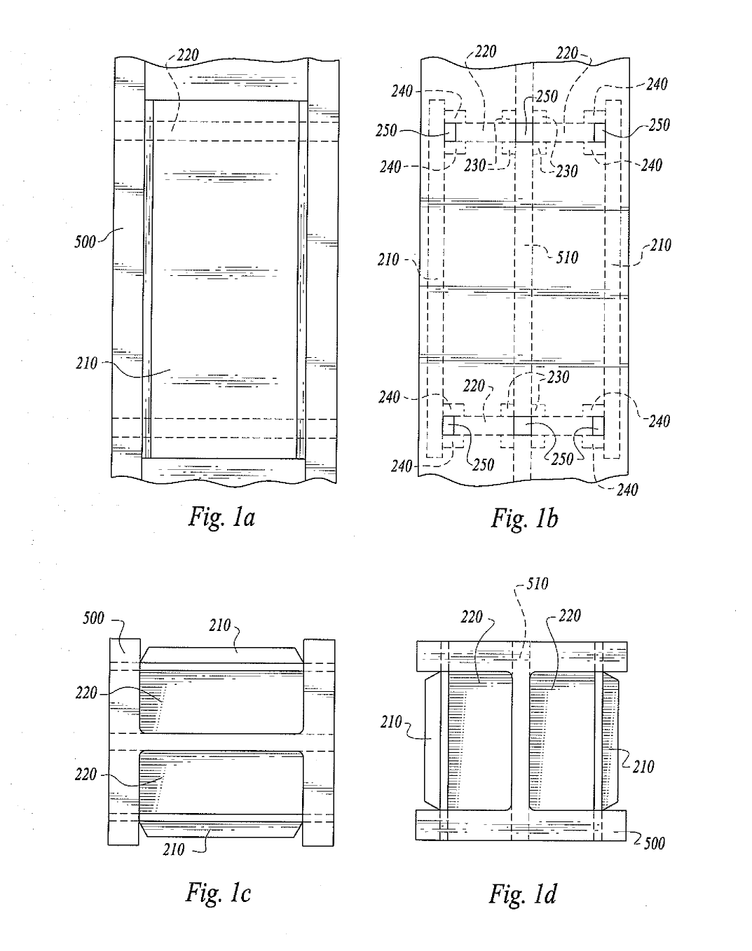

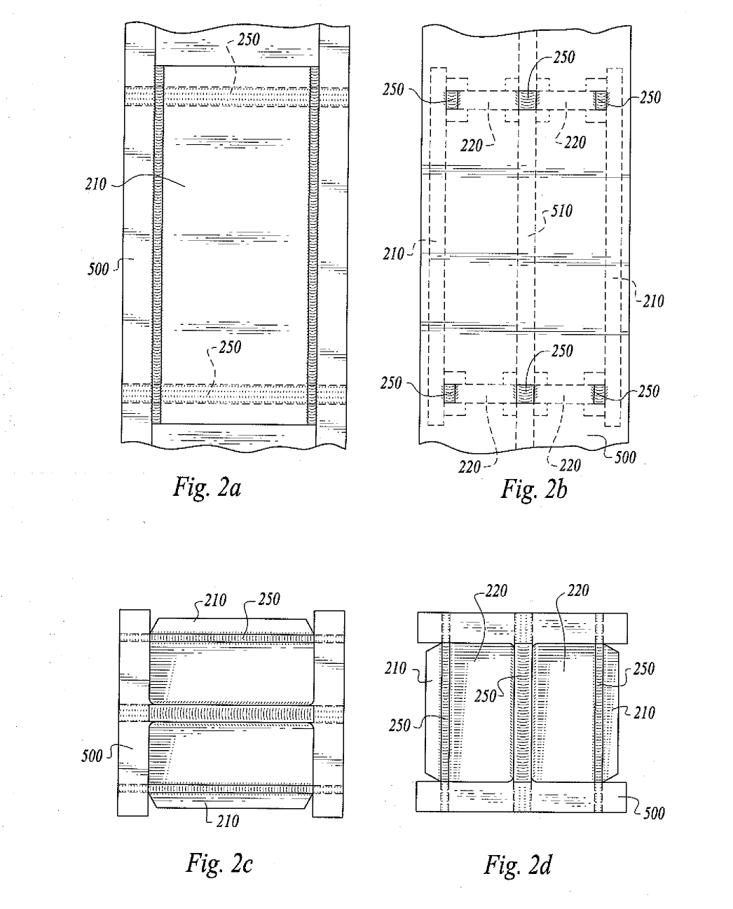

Referring more specifically to the drawings, for illustrative purposes the system and method for vertical moment connection welding is embodied generally in FIGS. 1a-11. It will be appreciated that the system may vary as to configuration and as to the details of the parts, and that the method of using the system may vary as to details and to the order of steps, without departing from the basic concepts as disclosed herein. The automated system and method for vertical moment connection welding are disclosed generally in terms of beam-to-column welding, as this particular type of welding operation is widely used. However, the disclosed automated system and method for vertical moment connection welding may be used in a large variety of welding applications, as will be readily apparent to those skilled in the art.

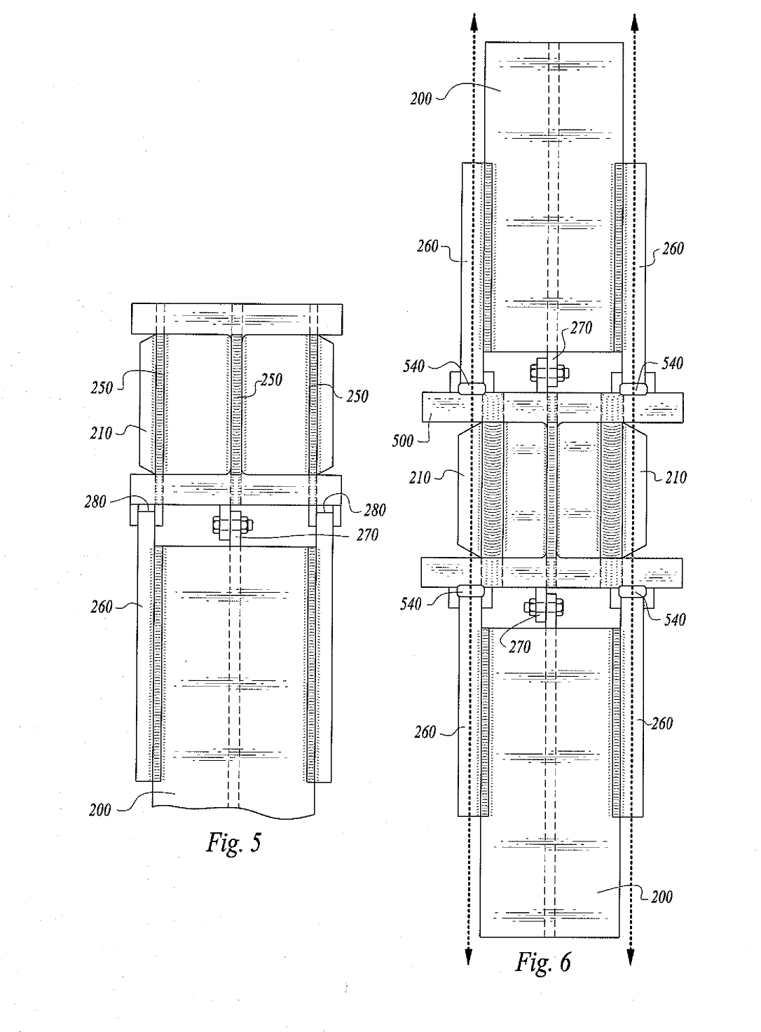

The automated system and method for (1) vertical welding the stiffeners in the column to the web with VertaSlag™ and (2) welding the stiffeners to the doubler plates with VertaSlag™ in the shop, and (3) welding the horizontal beam to the vertical column on the job site includes having the horizontal beam 200 bolted to the vertical column flange 500, FIGS. 4a, 4b, and 5. This bolted connection holds the horizontal beam 200 in position until the welding has been completed.

Two slots are cut in the web for welding of the moment plates to the web, FIGS. 1a and 1d. The width of the slot in the web is cut the same as the stiffener thickness. Two holes are cut in the flanges for each VertaSlag™ weld—one hole cut in the top flange above the weld cavity and the other cut in the bottom flange below the weld cavity. For illustration purposes, FIG. 1a, the two slots are illustrated with stiffeners; the top and bottom slots show stiffener plates 220 installed above and below the web 510. The doubler plate 210 above the stiffener plate 220 is not shown in this view.

As shown in FIG. 1b, the assemblies includes (1) a web 510 in the center of the vertical column 500 flange, (2) four stiffener plates 220, (3) eight stiffener backup bars 230 that retain the molten VertaSlag™ weld puddle, (4) a doubler plate 210 above the stiffener plates 220, (5) eight steel backup bars 240 above each stiffener-to-doubler plate that retain the molten VertaSlag™ weld puddle, and (6) six VertaSlag™ weld joints 250 (three to weld the top two stiffener plates 220 to the web 510, and the doubler plates 210; and three to weld the bottom two stiffener plates 220 to the web 510 and doubler plates 210).

The relationship between the stiffener plates and the top and bottom doubler plates is depicted in FIGS. 1c and 1d. Dotted lines show the holes cut in the two flange plates above and below the VertaSlag™ weld joints.

An embodiment of the automated system and method for vertical moment connection welding includes the following assembly sequence:
(1) two stiffeners are placed above the two slots cut in the web;
(2) the two stiffeners are held in place with one inch square backup bars tack welded on either side of the stiffener, connecting the stiffener to the web and providing a dam to retain the VertaSlag™ Weld puddle;
(3) two stiffeners are placed below the web, also held in place with two one inch square backup bars;
(4) two backup bars 240 are welded to the top side of each stiffener plate 220;
(5) each doubler plate 210 is placed on top of the four backup bars 240 that have been welded to the top of the stiffener plates 220 and tack welded into place;
(6) six sumps are welded to the bottom of each of the weld cavities 280 below the bottom flange; and
(8) six run-off “square-donut” tabs are placed above each VertaSlag™ weld cavity—all six welds are now prepared for welding.

An embodiment of the automated system and method for vertical moment connection welding includes the following welding sequence;
(1) consumable guide tubes (see my U.S. Pat. Nos. 7,148,443 and 7,550,692, and/or my '190 Application) are placed inside each of the six weld cavities, and each guide tube has sufficient insulation to keep the guide tube from shorting;
(2) six VertaSlag™ welding torches are used, one welding torch (see my '019 Application, my '297 Application, my '859 Application, and/or my '110 Application) is placed above each corresponding weld cavity;
(3) beveled copper bars are placed in the weld groove (between the doubler plate 210 and the column flange), on either side of the weld cavity, to keep the weld puddle from running down the submerged arc weld joint when the VertaSlag™ weld reaches the top of the weld cavity;
(4) one or two wire feed conduits are attached to each VertaSlag™ weld torch (see my '019 Application, my '297 Application, my '859 Application, and/or my '110 Application), wherein the size of guide tube and the number of welding wires used depends on the thickness of the stiffener 220 to be welded;
(5) a sufficient number of 4/0 cables to carry the necessary welding current are attached to each of the VertaSlag™ welding torches (see my '019 Application, my '297 Application, my '859 Application, and/or my '110 Application), and each weld is initiated one at-a-time to stagger the start and stop times, and when each weld has been completed, the corresponding welding torch is removed;
(6) each weld is initiated one at-a-time to stagger the start and stop times, and when each weld has been completed, the corresponding welding torch is removed;
(7) each remaining guide tube, starting sump, and run-off tabs are removed; and
(8) the final weld to join the doubler plate to either side of the column flanges is accomplished by the HD-SubArc+MP™ weld that is used to join the longitudinal side of the doubler plate to the inside of the beam flange, wherein metal powder is added to the weld joint prior to welding, and the weld is made with two ⅛ inch diameter dual-wires (through one torch tip) at amperages between 1000 and 2500 amps.

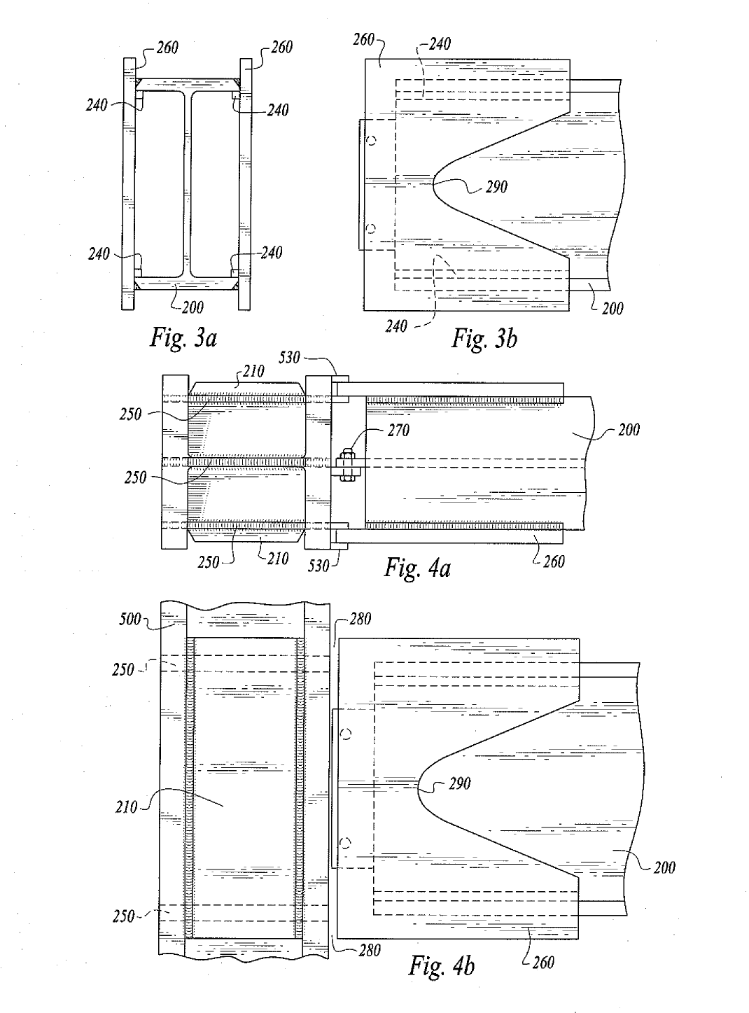

The horizontal beam 200 assembly is provided generally in FIGS. 3a-3b. In most cases, the horizontal beam 200 flange is narrower than the vertical column 500 flange. This allows two side plates 260 to be welded to the horizontal beam 200 flange. All four welds between the side plates 260 and the horizontal beam 200 flange are full penetration welds for the full length of the side plates 260. Backup bars 280 are used to retain the molten weld puddle and keep the welding process from burning through the horizontal beam 200 flange.

The horizontal beam 200 is shorter than the side plate 260, FIG. 3a. The web of the side plate 260 sticks out beyond the horizontal beam 200 flange and is bolted to another plate 270 that has been welded to the vertical column flange, FIGS. 4a-5. This bolted connection 270 is used to hold the horizontal beam 200 in position until the two VertaSlag™ welds join the side plates 260 to the vertical column 500 flange.

It is very important to recognize that the side plates 260 should perfectly align with the doubler plates 210 that have been welded into the Arcmatic™ moment connection inside the vertical column 500 flanges. This essential alignment helps carry the moment load through the vertical column 500 when a load is applied, such as wind or earthquake loading on the moment connection, FIG. 6.

For an embodiment of the automated system and method for vertical moment connection welding, FIG. 3b, an elliptical radius 290 is cut into the side plate 260 to reduce potential stress concentration during loading of the beam and beam-to-side plate connection. An embodiment includes an elliptical radius 290 in the side plate 260 that allows the horizontal beam 200 to flex up-and-down during loading without promoting crack propagation during the event causing the loading.

VertaSlag™ welds are used to weld the stiffener plates 220 to the web 510, and to weld the stiffener plates 220 to the doubler plates 210, FIGS. 4a and 4b. Longitudinal welds are used to join the doubler plates 210 to the inside of the vertical beam 500 flanges. The four full penetration welds (only the two top welds are depicted shown in the illustration) are used to join the side plate 260 to the horizontal beam 200.

It should be noted that the bolted web connection 270 will set the gap for the two VertaSlag™ welds that join the two side plates 260 to the vertical column 500 surface. Steel plates can be welded to the inside and outside of the VertaSlag™ weld joint to retain the molten puddle. Also, water-cooled copper shoes, or air-cooled copper shoes as disclosed in my '110 Application, could also be mounted on the inside and outside of the VertaSlag™ weld joint to retain the molten weld puddle. Both welds can be made at the same time to keep heat applied to the beam and column balanced. If there is a beam attached the opposite side of the vertical column, then all four welds are made simultaneously.

The VertaSlag™ welds join the horizontal beam side plates 260 to the vertical column 500 flanges, FIG. 5. It should be noted that the inside surface of the VertaSlag™ weld joint is a steel backup bar. This backup bar could be welded in the shop or in the field and would not have to be removed after the weld has been completed. As an option, water-cooled, or Air-cooled copper shoes are illustrated on the outside of the weld and can be removed after the weld has been completed. The bolted web connection 270 sets the gap for the VertaSlag™ weld.

The alignment of the side plates 260 on either side of the horizontal beam 200 to the doubler plates 210 on the inside of the vertical column 500 are depicted generally in FIG. 6. In this manner, a moment load is transferred through the moment connection in the vertical column 500 from one horizontal beam 200 to the other horizontal beam 200.

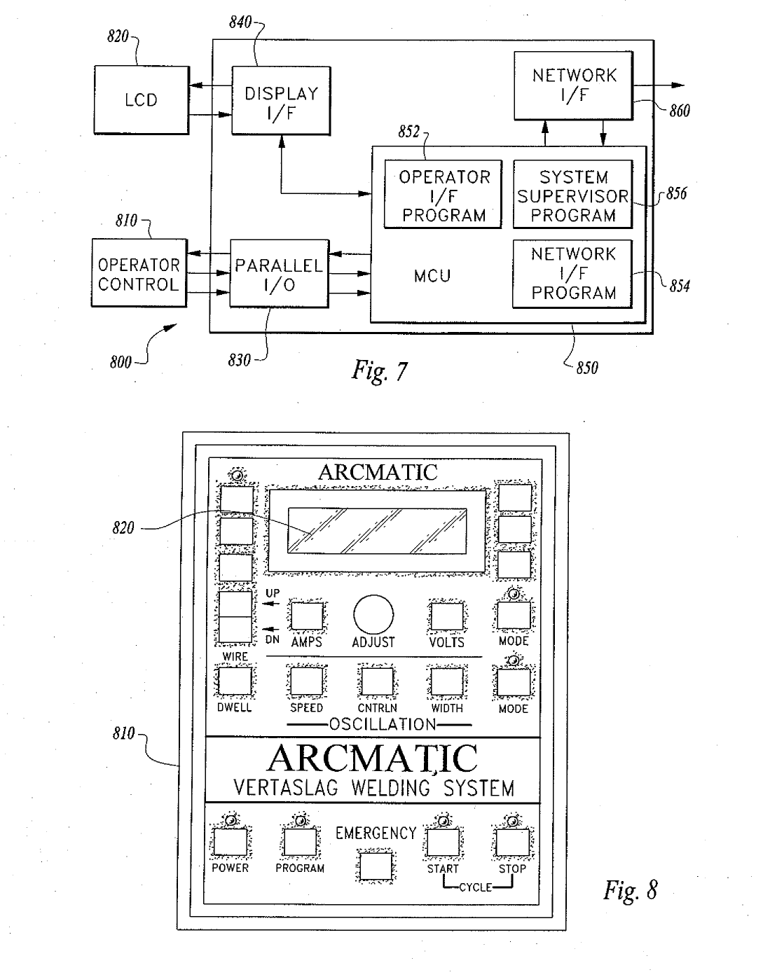

The welding process and the welding procedures for an embodiments of the method and system of the Arcmatic™ VertaSlag™ vertical moment connection welding can be pre-programmed into the Arcmatic™ programmable, computer controlled integrated welding system, FIGS. 7-11. The Arcmatic™ modular distributed welding control system 800 provides fully automatic control over the Arcmatic™ VertaSlag™ vertical moment connection from the operator's interface control panel 810. The Arcmatic™ VertaSlag™ vertical moment connection includes a single pendant controller that provides overall system control for a number of discreet motion control networks including microprocessor modular distributed control of each welding torch, each welding torch slide assembly, each in and out assembly, each wire feed conduit, each high current welding cable, welding power supply, and each weld within each welding cavity through a system supervisor program 856, network interface program 854, and an operator interface program 852 of a microprocessor control unit 850. An embodiment of the vertical moment connection includes a programmable welding fixture that clamps onto the horizontal beam.

Manual mode allows the operator to control the length of time for program and final conditions. Automatic mode provides timer based control of the system and method for vertical moment connection from when the “Cycle Start” button is pressed by the operator. Certain fault conditions terminate or prevent a welding cycle. The operator can switch from manual to automatic mode at any time during a welding cycle. The operator also has override control over any welding variable during the welding operation.

The operator interface panel 810, FIG. 8, provides overall control of the system, including set up and manual control of the of each welding torch, each welding torch slide assembly, each in and out assembly, each wire feed conduit, each high current welding cable, welding power supply, and each weld within each welding cavity. The operator interface also provides feedback to the operator and any errors that occur during the welding process. The system and method for beam-to-column welding is completely automatic once setup is complete.

The operator interface panel 810, FIG. 8, also includes switches to select various welding and system functions, mechanical encoders to set item values, control and position data and related graphics from the LCD graphics panel 820, and data packets returned by other system controller modules. Outputs include status indicator light emitting diodes (“LEDs”), the LED display panel, and data packets sent to other system controller modules. The operator interface panel 810 includes, and functions as, three separate programs—an operator interface program, a system supervisor program, and the network interface program—that pass data between and among themselves.

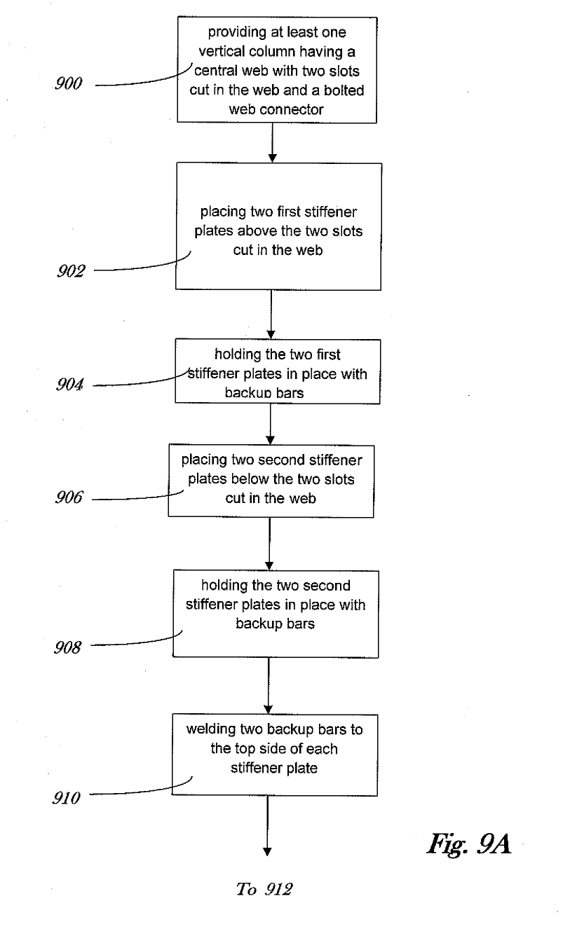

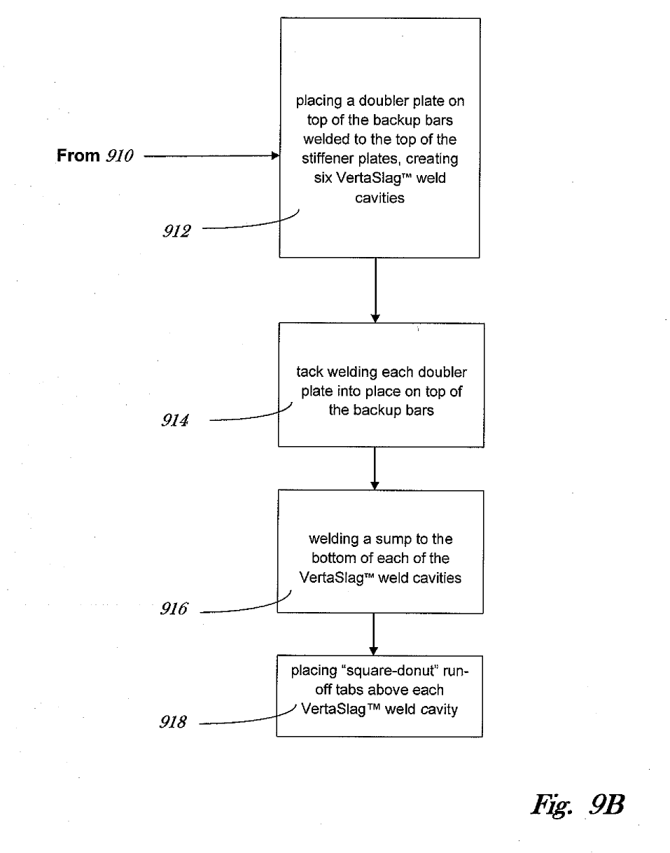

An embodiment of the automated modular method and process, FIGS. 9A-9B, for vertical moment connection welding includes the following steps:
a) providing at least one vertical column having a central web with two slots cut in the web and a bolted web connector 900;
b) placing two first stiffener plates above the two slots cut in the web 902;
c) holding the two first stiffener plates in place with backup bars tack welded on either side of the stiffener, connecting the stiffener to the web and providing a dam to retain a VertaSlag™ Weld puddle 904;
d) placing two second stiffener plates below the two slots cut in the web 906;
e) holding the two second stiffener plates in place with backup bars tack welded on either side of the stiffener, connecting the stiffener to the web and providing a dam to retain a VertaSlag™ Weld puddle 908;
f) welding two backup bars to the top side of each stiffener plate 910;
g) placing a doubler plate on top of the backup bars welded to the top of the stiffener plates, creating six VertaSlag™ weld cavities 912;
h) tack welding each doubler plate into place on top of the backup bars 914;
i) welding a sump to the bottom of each of the VertaSlag™ weld cavities below the bottom flange 916; and
j) placing “square-donut” run-off tabs above each VertaSlag™ weld cavity 918.

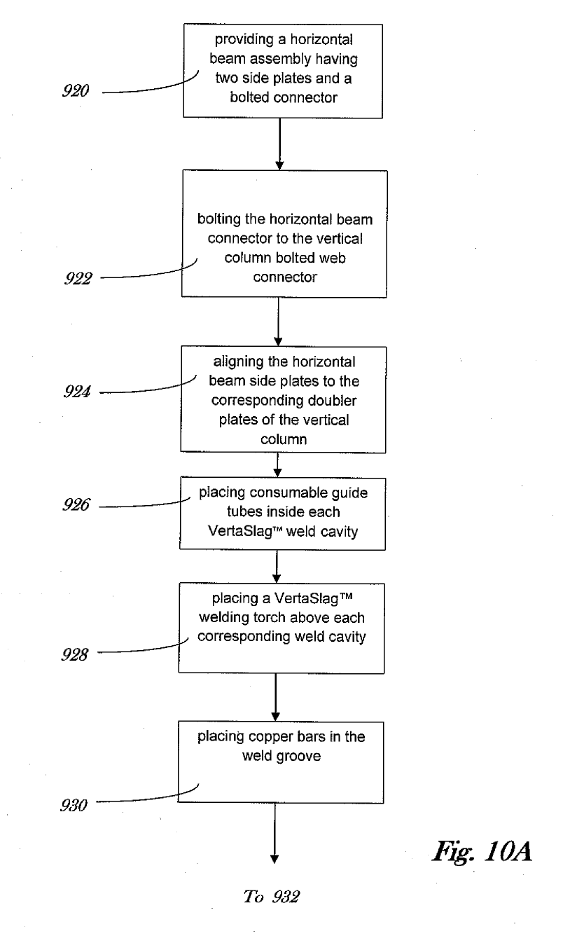

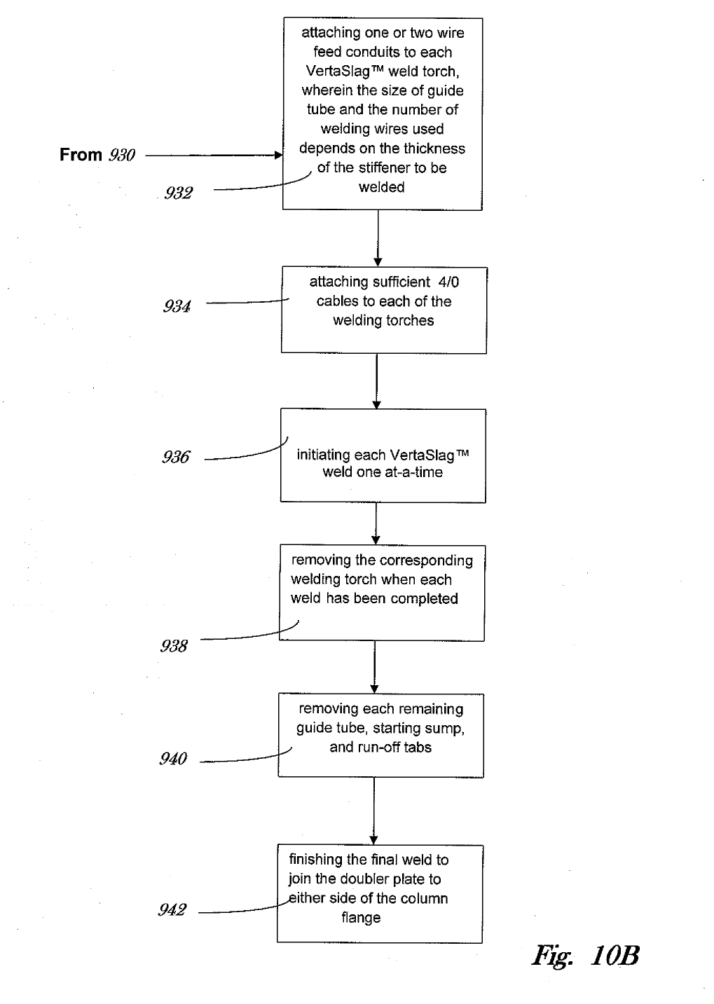

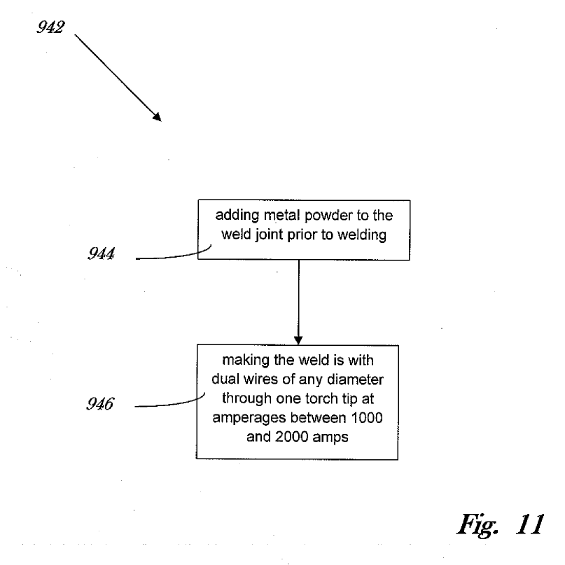

An embodiment of the automated modular method and process, FIGS. 9A-9B, for vertical moment connection welding further includes the following steps, FIGS. 10A-10B:
a) providing a horizontal beam assembly having two side plates and a bolted connector 920;
b) bolting the horizontal beam connector to the vertical column bolted web connector 922;
c) aligning the horizontal beam side plates to the corresponding doubler plates of the vertical column 924;
d) placing consumable guide tubes inside each VertaSlag™ weld cavity 926;
e) placing a VertaSlag™ welding torch above each corresponding weld cavity 928;
f) placing copper bars in the weld groove between the doubler plate and the vertical column flange on either side of the VertaSlag™ weld cavity 930;
g) attaching one or two wire feed conduits to each VertaSlag™ weld torch, wherein the size of guide tube and the number of welding wires used depends on the thickness of the stiffener to be welded 932;
h) attaching sufficient 4/0 cables to carry the necessary welding current are attached to each of the VertaSlag™ welding torches 934;
i) initiating each VertaSlag™ weld one at-a-time to stagger the start and stop times 936;
j) removing the corresponding welding torch when each weld has been completed 938;
k) removing each remaining guide tube, starting sump, and run-off tabs 940; and
l) finishing the final weld to join the doubler plate to either side of the column flange by the HD-SubArc+MP™ welding process to join the longitudinal side of the doubler plate to the inside of the beam flange 942.

Step 942 of an embodiment of the modular method and process for vertical moment connection welding further includes the following steps, FIG. 11:
a) adding metal powder to the weld joint prior to welding 944; and
b) making the weld is with dual wires of any diameter through one torch tip at amperages between 1000 and 2000 amps 946.

The welding process and the welding procedures for the embodiments of the automated system and method for vertical moment connection welding can be pre-programmed into an Arcmatic™ programmable, computer controlled integrated welding system. An embodiment of the automated system and method for vertical moment connection welding includes a programmable welding fixture that clamps onto the horizontal beam. Accordingly, the welding operator for any disclosed automated system and method for vertical moment connection welding necessarily does not need to be a certified welder; the operator principally needs to be a skilled operator capable of setting up the weld and running the pre-qualified welding programs. The same welding control system and methods used for Arcmatic™ VertaSlag™ welds, and/or my '019 Application, my '297 Application, my '859 Application, and/or my '110 Application are used to operate and control the method and system of electroslag beam-to-column welding including, but not limited to, automating the HD-SubArc+MP beam-to-column flange welds “on the job”, in the field.

Further, substantially the same consumable guide tubes of my U.S. Pat. Nos. 7,148,443 and 7,550,692, and/or my '190 Application are used for the system and method for vertical moment connection welding.

I claim:

1. A system for narrow-gap Electroslag-welded moment connection between vertical column flanges for construction of buildings, the system comprising:
a) at least one vertical column flange comprising a central web with two cut slots;
b) at least one first stiffener plate above each web cut slot;
c) two steel backup bars welded to each first stiffener plate and the web;
d) at least one second stiffener plate below each web cut slot;
e) two steel backup bars welded to each second stiffener plate and the web;
f) a doubler plate on top of the backup bars welded to the top of the stiffener plates, creating a plurality of weld cavities; and
g) at least one horizontal beam assembly having at least two side plates.

2. The system for narrow-gap Electroslag-welded moment connection between vertical column flanges for construction of buildings according to claim 1, the system further comprising bolted web connector assemblies on the vertical column central web and horizontal beam assembly.

3. The system for narrow-gap Electroslag-welded moment connection between vertical column flanges for construction of buildings according to claim 1, the system further comprising a welding sump at the bottom of each weld cavity.

4. The system for narrow-gap Electroslag-welded moment connection between vertical column flanges for construction of buildings according to claim 1, the system further comprising run-off tabs above each weld cavity.

5. The system for narrow-gap Electroslag-welded moment connection between vertical column flanges for construction of buildings according to claim 2, wherein at least one horizontal beam assembly is connected to at least one vertical column flange web through the corresponding bolted web connector assemblies whereby the horizontal beam assembly side plates are aligned with the corresponding vertical column doubler plates.

6. The system for narrow-gap Electroslag-welded moment connection between vertical column flanges for construction of buildings according to claim 1, the system further comprising consumable guide tubes, welding torches, welding cables, welding wire, and corresponding welding equipment for each welding cavity.

7. The system for narrow-gap Electroslag-welded moment connection between vertical column flanges for construction of buildings according to claim 6, the system further comprising at least one modular control interface for automated moment connection welding comprising:
a) at least one operator's control panel and display;
b) at least one parallel input and output unit;
c) at least one display interface;
d) at least one microprocessor control unit;
e) at least one operator interface program;
f) at least one network interface program;
g) at least one system supervisor program; and
h) at least one network interface.

8. The system for narrow-gap Electroslag-welded moment connection between vertical column flanges for construction of buildings according to claim 1, wherein each horizontal beam side plate comprise an elliptical radius.

9. A method for narrow-gap Electroslag-welded moment connection between vertical column flanges for construction of buildings, the method comprising the steps of:
a) providing at least one vertical column having a central web with two slots cut in the web and a bolted web connector;
b) placing two first stiffener plates above the two slots cut in the web;
c) holding the two first stiffener plates in place with backup bars tack welded on either side of the stiffener, connecting the stiffener to the web and providing a dam to retain a VertaSlag™ Weld puddle;
d) placing two second stiffener plates below the two slots cut in the web;
e) holding the two second stiffener plates in place with backup bars tack welded on either side of the stiffener, connecting the stiffener to the web and providing a dam to retain a VertaSlag™ Weld puddle;
f) welding two backup bars to the top side of each stiffener plate;
g) placing a doubler plate on top of the backup bars welded to the top of the stiffener plates, creating six VertaSlag™ weld cavities;
h) tack welding each doubler plate into place on top of the backup bars;
i) welding a sump to the bottom of each of the VertaSlag™ weld cavities below the bottom flange; and
j) placing “square-donut” run-off tabs above each VertaSlag™ weld cavity.

10. The method for narrow-gap Electroslag-welded moment connection between vertical column flanges for construction of buildings according to claim 9, the method further comprising the steps of:
a) providing a horizontal beam assembly having two side plates and a bolted connector;
b) bolting the horizontal beam connector to the vertical column bolted web connector;
c) aligning the horizontal beam side plates to the corresponding doubler plates of the vertical column;
d) placing consumable guide tubes inside each VertaSlag™ weld cavity;
e) placing a VertaSlag™ welding torch above each corresponding weld cavity;
f) placing copper bars in the weld groove between the doubler plate and the vertical column flange on either side of the VertaSlag™ weld cavity;
g) attaching one or two wire feed conduits to each VertaSlag™ weld torch, wherein the size of guide tube and the number of welding wires used depends on the thickness of the stiffener to be welded;
h) attaching sufficient 4/0 cables to carry the necessary welding current are attached to each of the VertaSlag™ welding torches;
i) initiating each VertaSlag™ weld one at-a-time to stagger the start and stop times;
j) removing the corresponding welding torch when each weld has been completed;
k) removing each remaining guide tube, starting sump, and run-off tabs; and
l) finishing the final weld to join the doubler plate to either side of the column flange by the HD-SubArc+MP™ welding process to join the longitudinal side of the doubler plate to the inside of the beam flange.

11. The method for narrow-gap Electroslag-welded moment connection between vertical column flanges for construction of buildings according to claim 10, wherein the step of finishing the final weld to join the doubler plate to either side of the column flange by the HD-SubArc+MP™ welding process to join the longitudinal side of the doubler plate to the inside of the beam flange further comprises the steps of:
a) adding metal powder to the weld joint prior to welding; and
b) making the weld is with dual wires through one torch tip at amperages between 1000 and 2000 amps.

12. The method for narrow-gap Electroslag-welded moment connection between vertical column flanges for construction of buildings according to claim 11, wherein all welding operations, processes, and equipment are controlled by at least one modular control interface for automated moment connection welding comprising:
a) at least one operator's control panel and display;
b) at least one parallel input and output unit;
c) at least one display interface;
d) at least one microprocessor control unit;
e) at least one operator interface program;
f) at least one network interface program;
g) at least one system supervisor program; and
h) at least one network interface.
